(19) United States
(12) Patent Application Publication
(10) Pub. No.: US 2022/0126468 A1
(43) Pub. Date: Apr. 28, 2022

(54) PET SHAVER WITH BUILT-IN VACUUM CLEANER

(71) Applicant: Qien Wang, Yiwu (CN)

(72) Inventor: Qien Wang, Yiwu (CN)

(21) Appl. No.: 17/079,423

(22) Filed: Oct. 24, 2020

(51) Int. Cl. B26B 19/44; B26B 19/38; B26B 19/24; B26B 19/20

(52) U.S. Cl. CPC B26B 19/44; B26B 19/205; B26B 19/24; B26B 19/3886

(57) ABSTRACT

The disclosure describes, a body housing; the shaving component is installed on the head of the housing, and the vacuum component is located at the inner end of the shaving component; the housing has a hair retraction cabin, and a hair retraction cabin cover is installed outside the cabin; the hair retraction cabin cover is fixedly installed on the housing through a retraction cabin fixing bracket.

### BACKGROUND OF THE INVENTION

### 1. Field of the Invention

The invention relates to a hair shaver, in particular to a pet shaver with built-in vacuum cleaner.

### 2. Description of the Related Art

Pet shavers are often used in pet grooming. The structures of these shavers are roughly the same, and the hair length regulation device is provided on the shaver to regulate the length. However, this kind of shaver has a common problem when in use, that is, the hair is exposed to the outside after being shaved. Once there is a large airflow, all the hair will be scattered, affecting the surrounding air environment, which is inconvenient to clean, and it is not hygienic in use.

### SUMMARY OF THE INVENTION

The technical problem to be solved by the invention is to provide a pet shaver with built-in vacuum cleaner, which can collect and store the shaved hair for convenient cleaning. Compared with the prior art, it is more environmentally friendly and hygienic and widely applicable to commercial and household use.

The invention is achieved by the following technical solutions: a pet shaver with built-in vacuum cleaner, comprising a body housing, wherein the body housing is provided with a built-in vacuum component and a dual-ring shaving component; the dual-ring shaving component is installed on the head of the body housing, and the vacuum component is located at the inner end of the dual-ring shaving component; the body housing is provided with a hair retraction cabin, and a hair retraction cabin cover is installed outside the hair retraction cabin; the hair retraction cabin cover is fixedly installed on the body housing through a retraction cabin fixing bracket.

Preferably, the dual-ring shaving component comprises a dual-ring razor blade driven by a motor and a hair length regulator; the hair length regulator is installed on the outside of the dual-ring razor blade.

Preferably, the vacuum component comprises a vacuum cleaner front panel, a front filter component, a rear filter component, a first connecting cover, and a second connecting cover; the first connecting cover is connected and assembled with the dual-ring razor blade; the first connecting cover and the second connecting cover are assembled and connected to each other; the vacuum cleaner front panel is installed between the dual-ring shaving component and the body housing; the rear filter component is installed inside the front filter component; the rear filter component and the second connecting cover are connected and assembled.

Preferably, the retraction cabin fixing bracket is butted with the output end of the front filter component.

Preferably, the inside of the hair retraction cabin is further provided with a retraction cabin filter cover.

Preferably, the body housing is provided with a handle, and the body housing is further provided with a power switch and a hair retraction cabin switch; the hair retraction cabin cover is opened through the hair retraction cabin switch.

Preferably, the body housing comprises a lower body panel and an upper body panel, and the lower body panel and the upper body panel are assembled and fixed by screws.

Preferably, one end of the body housing away from the dual-ring shaving component is provided with a ventilation ring, and the ventilation ring is provided with a ventilation hole.

The advantageous effects of the invention are: the invention uses the length regulation ring in front of the adjustable blade to regulate the length of the blade. The dual-ring razor blade cuts the hair of pets such as cats and dogs through the power transmitted by the motor, and then collects and stores the shaved hair for convenient cleaning. Compared with the prior art, it is more environmentally friendly and hygienic and widely applicable to commercial and household use.

### BRIEF DESCRIPTION OF THE DRAWINGS

In order to explain the embodiments of the invention or the technical solutions in the prior art more clearly, the drawings that need to be used in the description of the embodiments or the prior art will be introduced hereinafter. Obviously, the drawings in the following description are only some embodiments of the invention. For those of ordinary skill in the art, other drawings may be obtained from these drawings without creative efforts.

FIG. 1 is a schematic diagram of the overall structure of the invention;

FIG. 2 is a schematic diagram of the exploded structure of the invention.

### DETAILED DESCRIPTION OF THE PREFERRED EMBODIMENTS

All the features disclosed in the specification, or all disclosed methods or steps in the process, except for mutually exclusive features and/or steps, can be combined in any manner.

Any feature disclosed in the specification (including any appended claims, abstract and drawings), unless specifically stated, can be replaced by other equivalent or equivalent alternative features. That is, unless otherwise stated, each feature is just one example of a series of equivalent or similar features.

In the description of the invention, it needs to be understood that the orientation or positional relationship indicated by the terms “one end”, “the other end”, “outer”, “upper”, “inner”, “horizontal”, “coaxial”, “center”, “end”, “length”, “outer end”, etc. are based on the orientation or positional relationship shown in the drawings, which are only for the convenience of describing the invention and simplifying the description, rather than indicating or implying that the device or element referred to must have a specific orientation, be constructed and operated in a specific orientation, and therefore cannot be understood as a limitation of the invention.

In addition, in the description of the invention, “plurality” means at least two, such as two, three, etc., unless otherwise specifically defined.

The terms such as “upper”, “above”, “lower”, “below” and the like used in the invention to indicate a relative position in space are used to describe the relationship of one unit or feature relative to another unit or feature as shown in the drawings for the purpose of facilitating explanation. The term of the relative position in space may be intended to include different orientations of the device in use or operation other than those shown in the figures. For example, if the device in the figure is turned over, the unit described as being “lower” or “below” other units or features will be “above” the other units or features. Therefore, the exemplary term “below” can encompass both above and below orientations. A device can be oriented in other ways (rotated by 90 degrees or other orientations), and the space-related descriptors used in this article are explained accordingly.

In the invention, unless otherwise clearly defined and limited, the terms “provided”, “sleeved”, “connected”, “through”, “plug” and other terms should be interpreted broadly; for example, it can be a fixed connection, it can be a detachable connection, or integrated; it can be a mechanical connection or an electrical connection; it can be a direct connection, or an indirectly connection through an intermediate medium, and it can be an internal communication between two elements or the interaction relationship between two elements, unless specifically defined otherwise. For those of ordinary skill in the art, the specific meaning of the above terms in the invention can be understood according to specific circumstances.

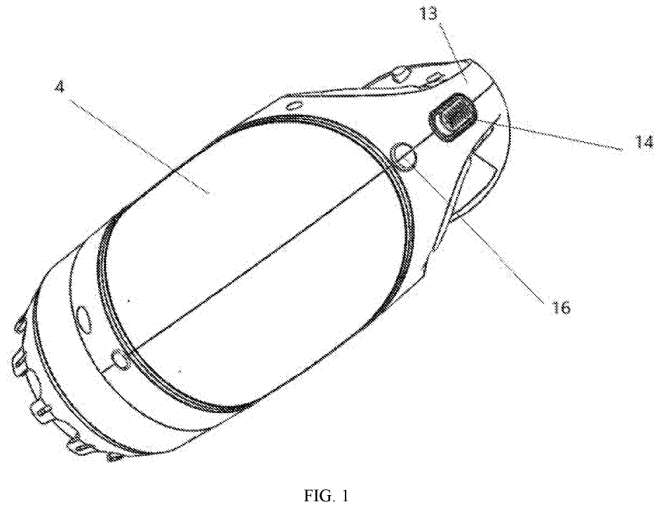

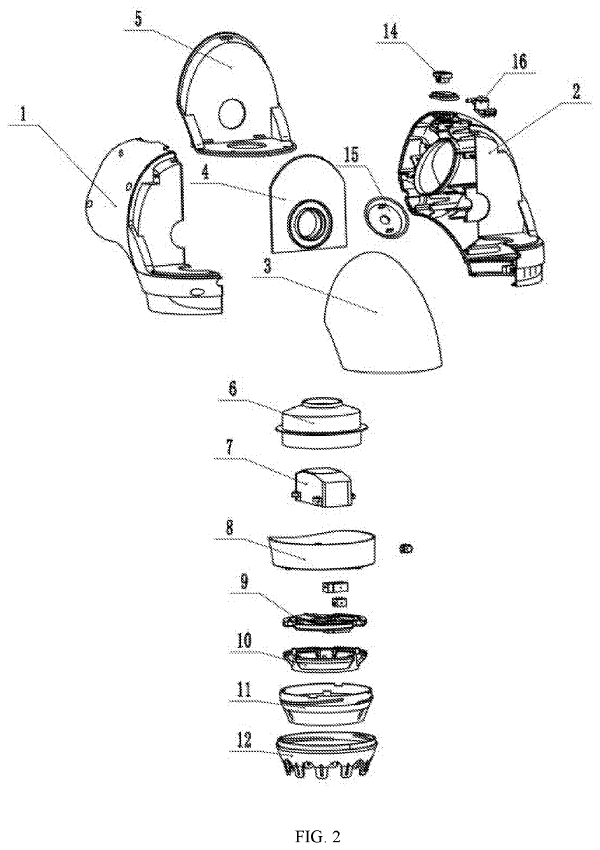

As shown in FIG. 1 and FIG. 2, a pet shaver with built-in vacuum cleaner of the invention, comprising a body housing, wherein the body housing is provided with a built-in vacuum component and a dual-ring shaving component; the dual-ring shaving component is installed on the head of the body housing, and the vacuum component is located at the inner end of the dual-ring shaving component; the body housing is provided with a hair retraction cabin, and a hair retraction cabin cover 3 is installed outside the hair retraction cabin; the hair retraction cabin cover 3 is fixedly installed on the body housing through a retraction cabin fixing bracket 5.

In the invention, the dual-ring shaving component comprises a dual-ring razor blade 11 driven by a motor and a hair length regulator 12; the hair length regulator 12 is installed on the outside of the dual-ring razor blade 11.

In the embodiment, the vacuum component comprises a vacuum cleaner front panel 8, a front filter component 6, a rear filter component 7, a first connecting cover 10, and a second connecting cover 9; the first connecting cover 10 is connected and assembled with the dual-ring razor blade 11; the first connecting cover 10 and the second connecting cover 9 are assembled and connected to each other; the vacuum cleaner front panel 8 is installed between the dual-ring shaving component and the body housing; the rear filter component 7 is installed inside the front filter component 6; the rear filter component 7 and the second connecting cover 9 are connected and assembled; the retraction cabin fixing bracket 5 is butted with the output end of the front filter component 6.

The inside of the hair retraction cabin 3 is further provided with a retraction cabin filter cover 4. The body housing is provided with a handle 13, and the body housing is further provided with a power switch 14 and a hair retraction cabin switch 16; the hair retraction cabin cover 3 is opened through the hair retraction cabin switch 16. When the hair retraction cabin is full of hairs, the cover can be opened through the hair retraction cabin switch 16, and then the hair can be taken out and cleaned, and then installed and used again, which is very convenient.

In the embodiment, the body housing comprises a lower body panel 1 and an upper body panel 2, and the lower body panel 1 and the upper body panel 2 are assembled and fixed by screws. One end of the body housing away from the dual-ring shaving component is provided with a ventilation ring 15, and the ventilation ring 15 is provided with a ventilation hole. The vacuum component generates negative pressure suction, which can be used to suck hair while shaving.

The shaved hair is blocked when it passes through the filter component, and the airflow is discharged through the ventilation hole, so as to continuously collect the hair, and the hair can be recycled into the hair retraction cabin for collection.

The working process is as follows:

The invention uses the length regulation ring in front of the adjustable blade to regulate the length of the blade. The dual-ring razor blade cuts the hair of pets such as cats and dogs through the power transmitted by the motor; at the same time, the vacuum cleaner built in the middle of the shaver will suck the shaved hair and store it in the hair collection device; finally, the user only needs to open the hair collection cover, which is convenient and quick to complete a shaving process without hair flying around. The invention is clean, environmentally friendly and hygienic and widely applicable to commercial and household use.

The above are only specific embodiments of the invention, but the protection scope of the invention is not limited thereto. Any modifications or substitutions creative efforts shall all fall within protection scope of the invention. Therefore, the protection scope of the invention should be subject to the protection scope defined by the claims.

What is claimed is:

1. A pet shaver, comprising a body housing, a dual-ring shaving component; the dual-ring shaving component is installed on the head of the body housing, and the vacuum component is located at inner end of the dual-ring shaving component; the body housing is provided with a hair retraction cabin, and a hair retraction cabin cover (3) is installed outside the hair retraction cabin; the hair retraction cabin cover (3) is fixedly installed on the body housing through a retraction cabin fixing bracket (5);
wherein the dual-ring shaving component comprises a dual-ring razor blade (11) and a hair length regulator (12); the hair length regulator (12) is installed on the outside of the dual-ring razor blade (11);
wherein the vacuum component comprises a vacuum cleaner front panel (8), a front niter component (6), a rear filter component (7), a first connecting cover (10), and a second connecting cover (9); the first connecting cover (10) is connected and assembled with the dual-ring razor blade (11); the first connecting cover (10) and the second connecting cover (9) are assembled and connected to each other; the vacuum cleaner front panel (8) is installed between the dual-ring shaving component and the body housing; the rear filter component (7) is installed inside the front filter component (6); the rear filter component (7) and the second connecting cover (9) are connected and assembled;
wherein the retraction cabin fixing bracket (5) is butted with the output end of the front filter component (6).

2. (canceled)

3. (canceled)

4. (canceled)

5. The pet shaver according to claim 1, wherein the inside of the hair retraction cabin cover (3) is further provided with a retraction cabin filter cover (4).

6. The pet shaver according to claim 1, wherein the body housing is provided with a handle (13), and the body housing is further provided with a power switch (14) and a hair retraction cabin switch (16); the hair retraction cabin cover (3) is opened through the hair retraction cabin switch (16).

7. The pet shaver according to claim 1, wherein the body housing comprises a lower body panel (1) and an upper body panel (2), and the lower body panel (1) and the upper body panel (2) are assembled and fixed by screws.

8. The pet shaver according to claim 1, wherein one end of the body housing away from the dual-ring shaving component is provided with a ventilation ring (15), and the ventilation ring (15) is provided with a ventilation hole.
